(19) United States
(12) Patent Application Publication
(10) Pub. No.: US 2024/0322538 A1
(43) Pub. Date: Sep. 26, 2024

(54) HOUSING BOX

(71) Applicant: YAZAKI CORPORATION, Tokyo (JP)

(72) Inventors: Ayumu Kurizono, Makinohara-shi (JP); Tsukasa Saito, Makinohara-shi (JP); Toshihisa Yagi, Tokyo (JP); Genki Murakoshi, Tokyo (JP)

(21) Appl. No.: 18/592,433

(22) Filed: Feb. 29, 2024

(30) Foreign Application Priority Data
Mar. 23, 2023 (JP) 2023-046149

(51) Int. Cl. H02G 3/08

(52) U.S. Cl. CPC H02G 3/081; H02G 3/088

(57) ABSTRACT

A housing box includes: a main body portion; an upper cover; and a packing member, in which the main body portion has an inner wall and an outer wall formed in an attachment direction of the upper cover at an end portion to which the upper cover is attached, and has a drain passage that is formed between the inner wall and the outer wall and drains water entering between the inner wall and the outer wall to the outside, and an end portion of the inner wall abuts on the packing member in a state where the upper cover is attached to the main body portion to block water ingress between the main body portion and the upper cover.

### CROSS-REFERENCE TO RELATED APPLICATION (S)

The present application claims priority to and incorporates by reference the entire contents of Japanese Patent Application No. 2023-046149 filed in Japan on Mar. 23, 2023.

### BACKGROUND OF THE INVENTION

### 1. Field of the Invention

The present invention relates to a housing box.

### 2. Description of the Related Art

Hitherto, for example, a housing box including an upper case openable and closable with respect to a lower case as described in Japanese Patent Application Laid-open No. 2001-072116 A is known as the housing box. In the housing box, a packing is disposed at a position where the upper case abuts on the lower case to block water ingress between the lower case and the upper case.

However, there is room for improvement in the above-described housing box in that there is a possibility of causing deterioration in water ingress blocking performance. For example, although the packing prevents water entering between the upper case and the lower case from entering an internal space of a case main body, water may accumulate between the upper case and the lower case. In this case, when a large amount of water frequently reaches the position of the packing, there is a possibility that it is difficult to block water ingress between the upper case and the lower case.

### SUMMARY OF THE INVENTION

Therefore, an object of the present invention is to provide a housing box with an improved water ingress blocking performance.

In order to achieve the above mentioned object, a housing box according to one aspect of the present invention includes a main body portion that is configured to house an object to be housed in the main body portion, and has an opening portion formed to communicate between an inside and an outside of the main body portion; a cover portion that is attached to the main body portion in such a way as to cover the opening portion; and a packing member that is provided in the cover portion, wherein the main body portion has an inner wall and an outer wall formed in an attachment direction of the cover portion at an end portion to which the cover portion is attached, and has a drain passage which is formed between the inner wall and the outer wall and drains water entering between the inner wall and the outer wall, and an end portion of the inner wall abuts on the packing member in a state where the cover portion is attached to the main body portion to block water ingress between the main body portion and the cover portion.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an exploded perspective view of a housing box according to an embodiment;

FIG. 2 is a perspective view of the housing box according to the embodiment;

FIG. 3 is a cross-sectional view of the housing box taken along line III-III of FIG. 2;

FIG. 4 is a cross-sectional view of the housing box taken along line IV-IV of FIG. 2; and

FIG. 5 is an explanatory view of a rebounding portion in the housing box according to the embodiment.

### DETAILED DESCRIPTION OF THE PREFERRED EMBODIMENTS

Hereinafter, an embodiment according to the present invention will be described in detail with reference to the drawings. Note that the present invention is not limited by the embodiment. In addition, constituent elements in the following embodiment include those that can be easily replaced by those skilled in the art or those that are substantially the same.

### Embodiment

The present embodiment relates to a housing box. In the following description, the first direction is referred to as a “depth direction X”, the second direction is referred to as a “width direction Y”, and the third direction is referred to as an “attachment direction Z”, the first direction, the second direction, and the third direction intersecting one another. Here, the depth direction X, the width direction Y, and the attachment direction Z are orthogonal to each other. The attachment direction Z is a direction in which a cover portion is attached to a main body portion, and corresponds to a height direction of the main body portion and the cover portion. The depth direction X and the width direction Y correspond to directions intersecting with the attachment direction Z. In addition, each direction used in the following description represents a direction in a state where the parts are assembled unless otherwise specified. The term “orthogonal” as used herein includes being substantially orthogonal.

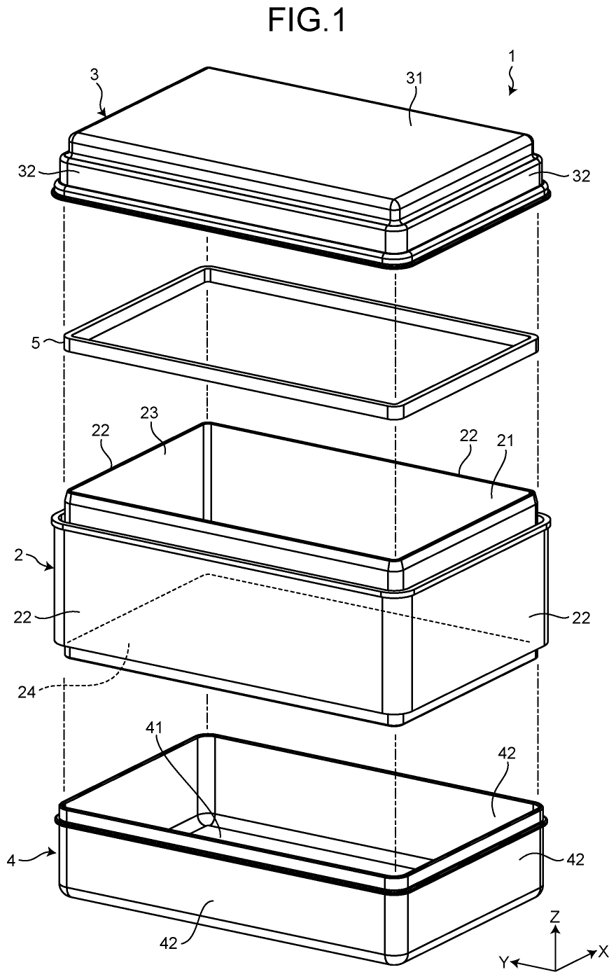

As illustrated in FIG. 1, a housing box 1 according to the present embodiment is a box that houses an object to be housed, and is used as, for example, an electrical connection box that is mounted on a vehicle and houses an electronic component including a fuse and a relay. The housing box 1 includes a main body portion 2, an upper cover 3, a lower cover 4, and a packing member 5. The main body portion 2 is a box member or a frame member whose upper surface and lower surface are open, and has, for example, a rectangular parallelepiped shape. The rectangular parallelepiped shape referred to herein includes a substantially rectangular parallelepiped shape. The main body portion 2 has, for example, four side walls 22, and is formed by arranging the side walls 22 in the attachment direction Z in which the upper cover 3 is attached and connecting the side walls 22 in the depth direction X and the width direction Y. The main body portion 2 has an internal space 21 for housing the electronic component therein.

The main body portion 2 has an opening portion 23 formed to communicate between the inside and the outside of the main body portion 2 on the upper surface, and an opening portion 24 formed to communicate between the interior and exterior on the lower surface. For example, the opening portion 23 is an opening that opens the entire upper surface of the main body portion 2, and the opening portion 24 is an opening that opens the entire lower surface of the main body portion 2. The opening portion 23 of the main body portion 2 is closed by attachment of the upper cover 3. The opening portion 24 of the main body portion 2 is closed by attachment of the lower cover 4.

The upper cover 3 is a cover portion that covers the opening portion 23 of the main body portion 2, and is attachable to and detachable from the main body portion 2. The upper cover 3 has a top surface portion 31 and a hanging portion 32. The top surface portion 31 is an upper surface portion of the upper cover 3, and has a shape conforming to the shape of the main body portion 2, for example, a rectangular shape or a substantially rectangular shape. The hanging portion 32 is a wall portion extending downward in the attachment direction Z from an outer edge of the top surface portion 31, and is formed over the entire outer edge of the top surface portion 31.

The lower cover 4 is a cover portion that covers the opening portion 24 of the main body portion 2, and is attachable to and detachable from the main body portion 2. The lower cover 4 has a bottom surface portion 41 and a side wall portion 42. The bottom surface portion 41 is a lower surface portion of the lower cover 4, and has a shape conforming to the shape of the main body portion 2, for example, a rectangular shape or a substantially rectangular shape. The side wall portion 42 is a plate-like portion extending upward in the attachment direction Z from an outer edge of the bottom surface portion 41, and is formed over the entire outer edge of the bottom surface portion 41. Although the lower cover 4 is attached on a lower side of the main body portion 2 in FIG. 1, the main body portion 2 may be formed integrally with the lower cover 4 to have a bottom portion. In addition, the housing box 1 may include a locking mechanism that locks the main body portion 2 and the upper cover 3 in an attached state, or a locking mechanism that locks the main body portion 2 and the lower cover 4 in an attached state.

The packing member 5 is a water ingress blocking member that blocks water ingress between the main body portion 2 and the upper cover 3. The packing member 5 is formed of a material having a lower rigidity than the upper cover 3, and is formed of, for example, an elastic resin such as an elastomer or an elastic member such as rubber. The packing member 5 is provided along a lower portion of the hanging portion 32 of the upper cover 3, and is formed in a rectangular ring shape that conforms to a shape of the lower portion of the hanging portion 32. The packing member 5 may be provided by, for example, two-color molding with the upper cover 3, or may be provided separately from the upper cover 3 and fitted to the upper cover 3.

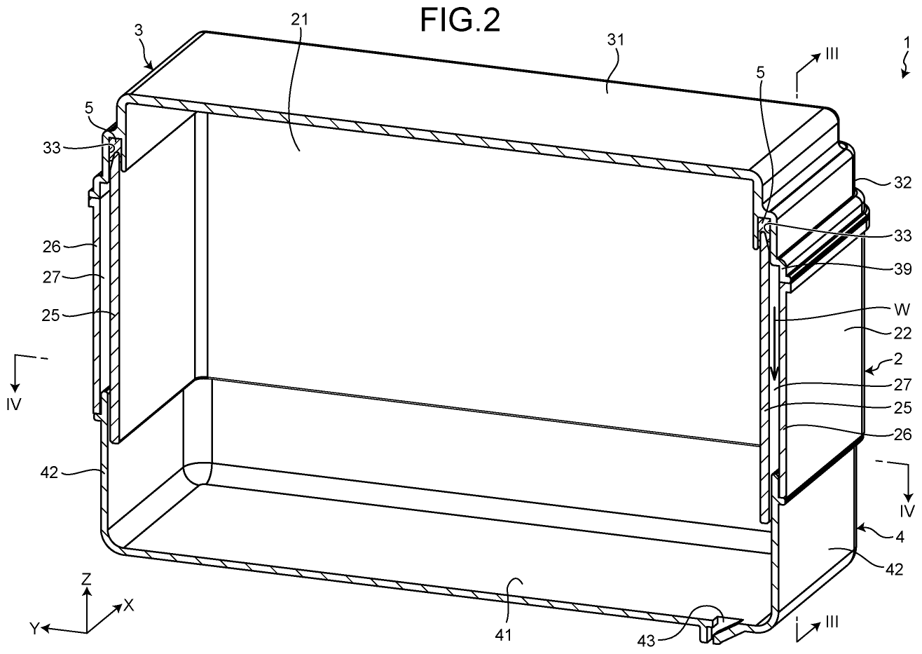

As illustrated in FIG. 2, the packing member 5 is provided on the upper cover 3, is disposed between the main body portion 2 and the upper cover 3, and blocks water ingress between the main body portion 2 and the upper cover 3. FIG. 2 is a perspective view of the housing box 1 in a state where the upper cover 3 and the lower cover 4 are attached to the main body portion 2, and illustrates the housing box 1 in a state where almost half of the housing box 1 is cut. The packing member 5 is provided, for example, in a housing space 33 formed at the lower portion of the hanging portion 32 of the upper cover 3. The housing space 33 is a groove-shaped space opened downward, and is continuously formed in the depth direction X and the width direction Y along the lower portion of the hanging portion 32.

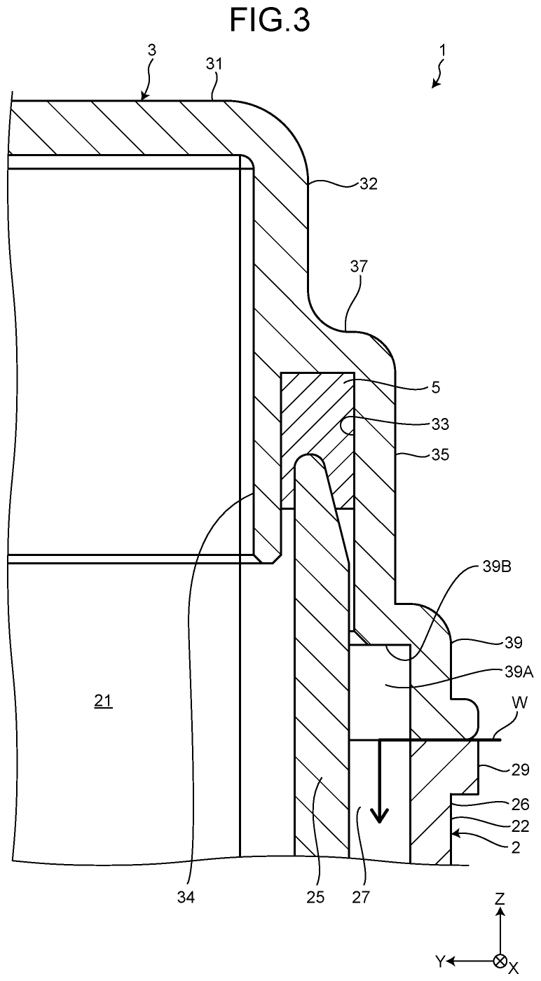

As illustrated in FIG. 3, the packing member 5 is provided in the housing space 33 formed in the upper cover 3. FIG. 3 is an enlarged cross-sectional view of the housing box 1, illustrating a state where the upper cover 3 is attached to the main body portion 2 and a case in which the packing member 5 is provided on the upper cover 3. The upper cover 3 has an inner wall 34 and an outer wall 35 formed in the attachment direction Z at the lower portion of the hanging portion 32, and the housing space 33 capable of housing the packing member 5 is formed at a base end portion between the inner wall 34 and the outer wall 35. The outer wall 35 is spaced outward from the inner wall 34.

The inner wall 34 is a wall portion extending downward at the lower portion of the hanging portion 32, and functions as a cover portion side inner wall. The outer wall 35 is a wall portion branching outward from the inner wall 34 via a protruding portion 37, and functions as a cover portion side outer wall. The protruding portion 37 is provided in such a way as to protrude outward from a base end portion of the inner wall 34, and the outer wall 35 extends downward from a protruding distal end of the protruding portion 37. The outer wall 35 has, for example, a rebounding portion 39 that extends downward in parallel with the inner wall 34 at a base end portion thereof and is bent outward and then bent downward at a lower portion thereof. Details of the rebounding portion 39 will be described later. A lower end of the outer wall 35 comes into contact with a protrusion 29 formed on the side wall 22, and is supported by the protrusion 29. The protrusion 29 is a portion protruding outward from the side wall 22, and extends continuously in the depth direction X and the width direction Y, for example.

The housing space 33 is a space for housing the packing member 5 and has a larger width in the width direction Y and a larger height in the attachment direction Z larger as compared with a thickness of the hanging portion 32, for example. In addition, the housing space 33 has a larger width in the width direction Y and a larger height in the attachment direction Z as compared with a thickness of an inner wall 25, for example. The side wall 22 of the main body portion 2 has the inner wall 25 and an outer wall 26. For example, the side wall 22 has an inner-outer dual-wall structure including the inner wall 25 and the outer wall 26, and the inner wall 25 and the outer wall 26 are spaced apart from each other. The inner wall 25 is a wall portion formed in the attachment direction z, and functions as a main body portion side inner wall. The outer wall 26 is a wall portion formed in the attachment direction Z, and functions as a main body portion side outer wall.

The inner wall 25 of the main body portion 2 is inserted between the inner wall 34 and the outer wall 35 of the upper cover 3 and abuts on the packing member 5. That is, the inner wall 25 is inserted into the housing space 33 and abuts on the packing member 5 in a state where the upper cover 3 is attached to the main body portion 2. Therefore, the packing member 5 is brought into pressure contact with the main body portion 2 and the upper cover 3 to seal between the main body portion 2 and the upper cover 3. Therefore, the packing member 5 prevents water W from entering the internal space 21 through between the main body portion 2 and the upper cover 3.

In the main body portion 2, a drain passage 27 for draining the water W entering between the outer wall 26 and the inner wall 25 to the outside is formed. The drain passage 27 is a space formed between the outer wall 26 and the inner wall 25, and is formed from an upper portion to a lower portion of the side wall 22. As illustrated in FIG. 2, even when the water W enters between the outer wall 26 and the inner wall 25 from the outside, the water W flows downward in the housing box 1 and is drained to the outside through the drain passage 27. For example, the water W flowing downward in the drain passage 27 is drained to the outside from between the side wall portion 42 and the outer wall 26, or falls onto the bottom surface portion 41 of the lower cover 4 and is drained to the outside from a drain port 43 formed in the bottom surface portion 41.

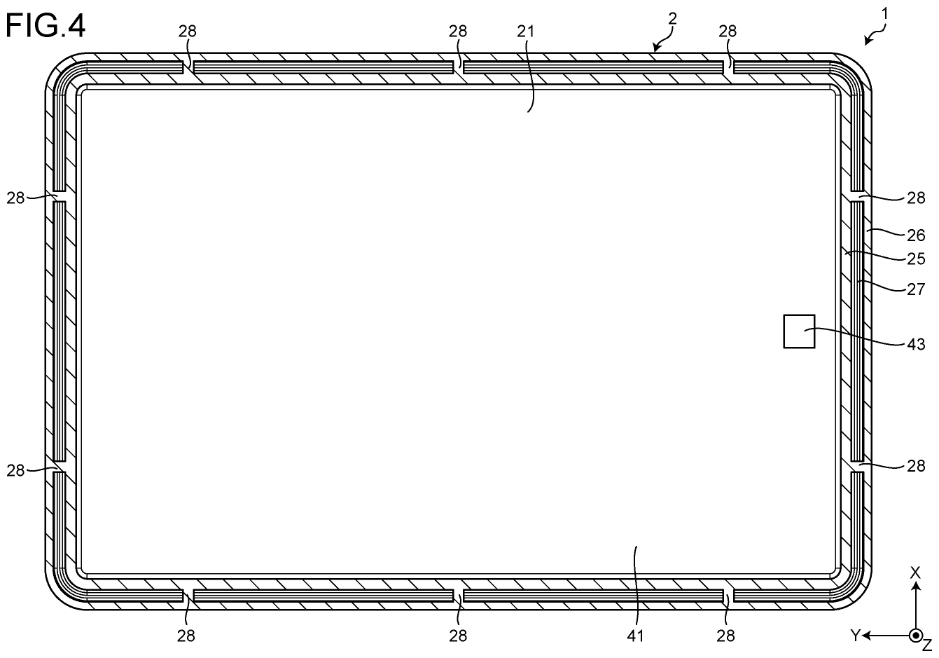

As illustrated in FIG. 4, the inner wall 25 and the outer wall 26 are connected by a plurality of ribs 28 at predetermined intervals in the depth direction X and the width direction Y, and are supported in a spaced state. A region where the rib 28 is not formed between the inner wall 25 and the outer wall 26 functions as the drain passage 27.

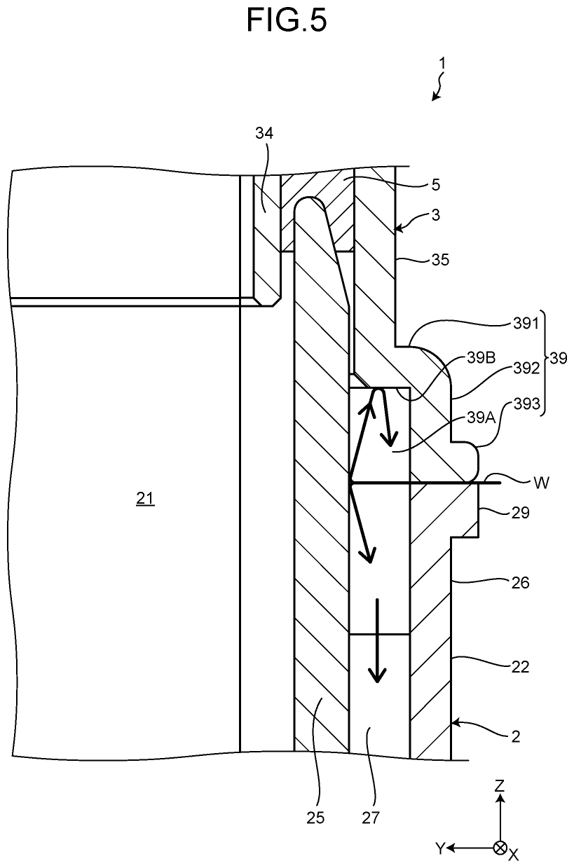

As illustrated in FIG. 5, the upper cover 3 has the rebounding portion 39. The rebounding portion 39 is a portion for rebounding the water W entering between the outer wall 26 and the inner wall 25 and rising upward, and has a rebounding space 39A connected to the drain passage 27 above the drain passage 27. The rebounding space 39A is formed to have the same width as the drain passage 27 in the depth direction X and the width direction Y (the width direction Y in FIG. 5), for example. The rebounding portion 39 is provided at a lower portion of the outer wall 35 and has a protruding portion 391, a hanging portion 392, and a protrusion 393. The protruding portion 391 is a portion that is bent outward and protrudes at the lower portion of the outer wall 35. The hanging portion 392 is provided to hang downward from a distal end of the protruding portion 391. The protrusion 393 is a portion protruding outward from a lower portion of the hanging portion 392, and is in contact with the protrusion 29 formed on the outer wall 26.

The rebounding space 39A is formed to be surrounded by the protruding portion 391, the hanging portion 392, the protrusion 393, and the inner wall 25. The rebounding portion 39 has a rebounding surface 39B forming a ceiling portion of the rebounding space 39A. For example, the rebounding surface 39B is formed on an inner surface of the protruding portion 391. The rebounding surface 39B is a surface formed in a direction intersecting the attachment direction z, and is formed, for example, in a direction orthogonal to the attachment direction Z. The term “orthogonal” as used herein includes being substantially orthogonal. The rebounding surface 39B functions as a surface for rebounding the water W rising upward downward.

Next, the water ingress blocking performance of the housing box 1 according to the present embodiment will be described.

In the housing box 1, the packing member 5 blocks water ingress between the main body portion 2 and the upper cover 3, and the water ingress blocking performance is enhanced by the drain passage 27. In FIG. 3, when the upper cover 3 is attached to the main body portion 2, the inner wall 25 abuts on the packing member 5 provided on the upper cover 3. As a result, the packing member 5 is brought into pressure contact with the main body portion 2 and the upper cover 3. Therefore, a space between the main body portion 2 and the upper cover 3 is sealed by the packing member 5, and thus, water ingress between the main body portion 2 and the upper cover 3 is blocked.

Here, it is conceivable that the water W enters from between the outer wall 35 of the upper cover 3 and the outer wall 26 of the main body portion 2 in the housing box 1. In this case, although the water W enters between the inner wall 25 and the outer wall 26 of the main body portion 2, the water W flows downward and is drained to the outside of the housing box 1 through the drain passage 27.

At this time, in a case where the drain passage 27 is not provided in the housing box 1, the water W accumulates between the inner wall 25 and the outer wall 26 of the main body portion 2. When vibration is applied to the housing box 1 in this state, there is a possibility that the water W reaches the position of the packing member 5 many times and enters between the packing member 5 and the inner wall 25.

On the other hand, in the housing box 1 according to the present embodiment, the water W reaching a position in front of the packing member 5 is drained to the outside of the housing box 1 through the drain passage 27. Therefore, the amount of water W reaching the position of the packing member 5 can be reduced. Therefore, the housing box 1 according to the present embodiment can prevent the water W from entering between the packing member 5 and the inner wall 25. In addition, since the housing box 1 according to the present embodiment includes the packing member 5 and the drain passage 27, it is possible to improve the water ingress blocking performance between the main body portion 2 and the upper cover 3 with a simple structure.

Further, it is conceivable that the water W having a high water pressure is sprayed onto the housing box 1 as illustrated in FIG. 5. In this case, the water W in a high pressure state enters from between the outer wall 35 of the upper cover 3 and the outer wall 26 of the main body portion 2. The water W enters between the inner wall 25 and the outer wall 26 of the main body portion 2, and travels while splashing upward and downward.

At this time, even when the water W splashes upward, the housing box 1 can accurately guide the water W to the drain passage 27 below. That is, most of the water W splashing upward collides with the rebounding surface 39B and is rebounded downward by the rebounding surface 39B, thereby preventing the water W from reaching the packing member 5. Therefore, the housing box 1 can reduce the amount of water W reaching the packing member 5. As a result, the housing box 1 can accurately prevent the water W from entering between the packing member 5 and the inner wall 25, and can improve the water ingress blocking performance between the main body portion 2 and the upper cover 3.

Since the housing box 1 according to the present embodiment includes the packing member 5 and the drain passage 27 as described above, it is possible to improve the water ingress blocking performance between the main body portion 2 and the upper cover 3.

In addition, since the housing box 1 according to the present embodiment includes the rebounding portion 39 having the rebounding surface 39B, the water W entering between the inner wall 25 and the outer wall 26 can be accurately drained.

Furthermore, in a case where the housing box 1 according to the present embodiment is used as an electrical connection box that is mounted on a vehicle and houses an electronic component, it is possible to enhance a water ingress blocking performance of the electrical connection box.

Although the housing box 1 according to the embodiment has been described above, the housing box according to the present invention is not limited to the above-described embodiment, and various modifications can be made within the scope described in the claims. In addition, the housing box 1 according to the present embodiment may be configured by appropriately combining the constituent elements of the above-described embodiment and the modifications.

In addition, although an electrical connection box that is mounted on a vehicle and houses an electronic component is applied as the housing box 1 has been described in the above-described embodiment, but the housing box according to the present invention may be applied to a housing box that is not mounted on a vehicle. In addition, the housing box according to the present invention may be applied to a housing box that houses an object to be housed other than an electronic component.

The housing box of the present embodiment can have an improved water ingress blocking performance.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A housing box comprising:
a main body portion that is configured to house an object to be housed in the main body portion, and has an opening portion formed to communicate between an inside and an outside of the main body portion;
a cover portion that is attached to the main body portion in such a way as to cover the opening portion; and
a packing member that is provided in the cover portion, wherein
the main body portion has an inner wall and an outer wall formed in an attachment direction of the cover portion at an end portion to which the cover portion is attached, and has a drain passage which is formed between the inner wall and the outer wall and drains water entering between the inner wall and the outer wall, and
an end portion of the inner wall abuts on the packing member in a state where the cover portion is attached to the main body portion to block water ingress between the main body portion and the cover portion.

2. The housing box according to claim 1, wherein
the cover portion has a rebounding portion having a rebounding space connected to the drain passage above the drain passage, and
the rebounding portion has a rebounding surface formed at a ceiling portion of the rebounding space in a direction intersecting the attachment direction.

3. The housing box according to claim 1, wherein
the housing box is an electrical connection box that is mounted on a vehicle and houses an electronic component as the object to be housed.

4. The housing box according to claim 2, wherein
the housing box is an electrical connection box that is mounted on a vehicle and houses an electronic component as the object to be housed.
